(19) United States
(12) Patent Application Publication
(10) Pub. No.: US 2020/0086945 A1
(43) Pub. Date: Mar. 19, 2020

(54) Quick Release Pedal for a Bicycle

(71) Applicant: JURONG CHIIH SHIN PRECISION HARWARE PARTS CO., LTD., Jiangsu (CN)

(72) Inventor: Ching-Hui CHEN, Taichung City (TW)

(73) Assignee: Jurong Chiih Shin Precision Hardware Parts Co., Ltd.

(21) Appl. No.: 16/449,073

(22) Filed: Jun. 21, 2019

(30) Foreign Application Priority Data
Sep. 13, 2018 (CN) 201821495550.5

(51) Int. Cl. B62M 3/08

(52) U.S. Cl. CPC B62M 3/08

(57) ABSTRACT

A quick release pedal for a bicycle essentially includes a pedal body, a shaft and an outer nut. By lengthening the assembling portion of the shaft, the assembling portion can extend out of the shaft hole of the pedal body, and the outer nut is added and disposed on the assembling portion and can be assembled and disassembled with a pneumatic tool to accelerate assembling or disassembling of the pedal, effectively shortening the assembling man-hour and reducing labor cost. The pedal is assembled from another end of the pedal body, which improves the defects of the conventional operation space being narrow and small, significantly expands the operation space to enable the assembler to perform assembling in a more ergonomic manner, therefore, the assembler will not be fatigued during the assembling process, and the assembling will be smooth, convenient and safe.

### BACKGROUND

### Field of the Invention

The present invention relates to a pedal, and more particularly to a quick release pedal for a bicycle.

### Related Prior Art

Bicycles have been transformed from the original replacement for walking to one of the leisure and healthy living tools. Lightweight, non-fuel-consumption and the features of environmentally-friendly and sports all are the advantages of bicycles. A bicycle is generally provided with pivotable pedals 1 for the user's feet to step on to drive the wheel of the bicycle. The structure of each of pedals 1 includes a pedal body 2, and a rotary shaft 3 inserted in the pedal body 2 and having one end fixed to the crank of the bicycle (not shown).

The pedals of a conventional bicycle are generally installed in two ways, one is to use an open-end wrench to engage the crank of the rotary shaft 3 and fix it to the crack of the bicycle, and the other is to use an Allen wrench to fix the rotary shaft to the crank of the bicycle from the inside of the bicycle. There are some defects that the operation space is too small, the assembler is likely to be blocked by the bicycle frame or the crank, the assembling is unsmooth, substantially increasing the difficulty of assembling. Furthermore, the structure of the assembly is quite complicated and the assembly is not easy, which is likely to cause injury of the assembler, so the assembling process is labor-intensive and time-consuming, which inevitably increases the manufacturing cost, causing much inconvenience and reducing assembly efficiency.

In addition, due to the small operation space, the problem of inaccurate alignment is easy to occur, resulting in the pedals of the bicycle not having an accurate locking position. When the user rides the bicycle, the pedals 1 are likely to falling off from the crank, affecting the image of the bicycle brand. Besides, the assembly personnel may apply inappropriate torque to cause damage or deformation of the components due to excessive or too small torque.

The present invention has arisen to mitigate and/or obviate the afore-described disadvantages.

### SUMMARY

One objective of the present invention is to provide a quick release pedal for a bicycle, which can be assembled and disassembled easily to improve the assembling and disassembling efficiency.

To achieve the above objective, a quick release pedal for a bicycle provided by the present invention comprises:

a pedal body including a shaft hole and an end portion at one end of the pedal body;

a shaft inserted in the shaft hole and including a connecting portion connecting a crank of the bicycle, and an assembling portion located opposite to the connecting portion and toward the end portion, the assembling portion extending out of the shaft hole; and

an outer nut sleeved on the assembling portion and at a distance from the end portion.

Preferably, the quick release pedal further comprises two bearings and an inner nut, the shaft hole is provided with two opposite step portions, the two bearings are respectively abut against the two step portions, and the inner nut has one end abutted against one of the two bearings, and another end for the outer nut to abut against.

Preferably, an outer diameter of the outer nut is larger than that of the inner nut.

Preferably, the end portion is provided with a through hole aligned with one end of the outer nut.

Preferably, the outer nut is polygonal.

Preferably, a positioning portion is protruded from an inner surface of the outer nut to provide for the assembling portion to abut against.

Preferably, an inner diameter of a middle section of the shaft hole is smaller than an inner diameter at both ends of the shaft hole.

A quick release bicycle pedal structure essentially includes a pedal body, a shaft and an outer nut. By lengthening the assembling portion of the shaft, the assembling portion can extend out of the shaft hole of the pedal body, and the outer nut is added and disposed on the assembling portion and can be assembled and disassembled with a pneumatic tool to accelerate assembling or disassembling of the pedal, effectively shortening the assembling man-hour and reducing labor cost. The pedal of the present invention is assembled from another end of the pedal body, which improves the defects of the conventional operation space being narrow and small, significantly expands the operation space to enable the assembler to perform assembling in a more ergonomic manner, therefore, the assembler will not be fatigued during the assembling process, and the assembling will be smooth, convenient and safe.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a cross-sectional view of a conventional pedal structure;

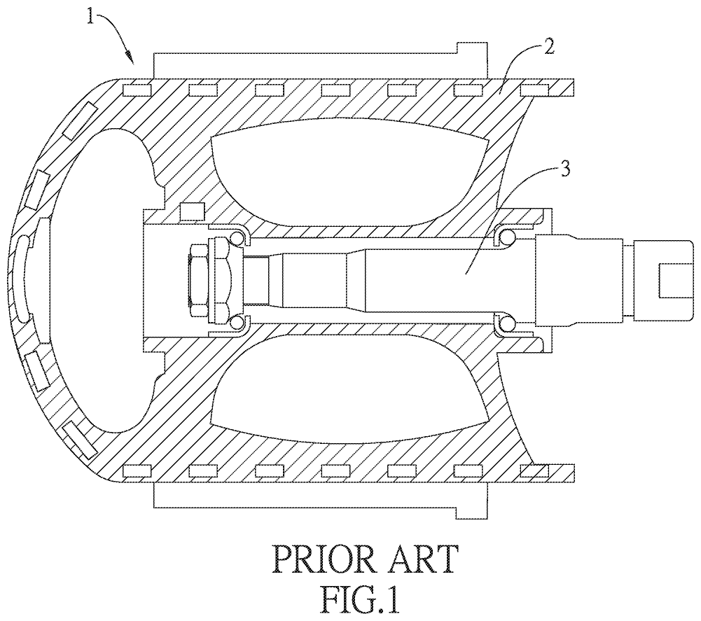

FIG. 2 is a cross-sectional view of a quick release pedal for a bicycle in arrogance with a preferred embodiment of the present invention;

FIG. 3 is a magnified view of a part of the preferred embodiment of the present invention, showing the outer nut; and

FIG. 4 is a schematic illustration of the embodiment of the present invention showing the use of a pneumatic tool to rotate the outer nut.

### DETAILED DESCRIPTION

The present invention will be clearer from the following description when viewed together with the accompanying drawings, which show, for purpose of illustrations only, the preferred embodiment in accordance with the present invention.

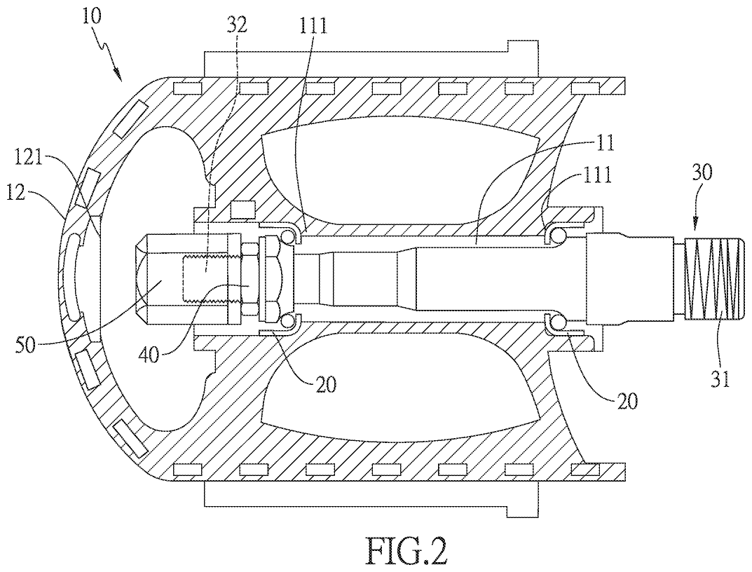

Referring to FIGS. 2-4, a quick release pedal for a bicycle in accordance with the present invention comprises a pedal body 10, two bearings 20, a shaft 30, an inner nut 40, and an outer nut 50.

The pedal body 10 includes a shaft hole 11 and an end portion 12 at one end. Specifically, the shaft hole 11 is provided with two opposite step portions 111, and an inner diameter of a middle section of the shaft hole 11 is smaller than an inner diameter at both ends of the shaft hole 11.

The two bearings 20 are disposed in the shaft hole 11 and respectively abut against the two step portions 111.

The shaft 30 is inserted in the shaft hole 11, tapered toward the end portion 12, and includes: a connecting portion 31 extending out of the shaft hole 11 to connect a crank (not shown) of a bicycle, an assembling portion 32 which is located opposite to the connecting portion 31 and toward the end portion 12, and extends out of the shaft hole 11. In the prior art, the assembling of pedals is performed at a position adjacent to the crank, so the assembling space is limited, making the assembling unsmooth. However, the assembling of pedals of the present invention is performed at the end of the shaft 30 farther away from the crank, wherein the assembling portion 32 is lengthened by about 10 mm whereby to protrude from the shaft hole 11.

The inner nut 40 is disposed in the shaft hole 11 and has one end abutted against one of the bearings 20 adjacent to the end portion 12.

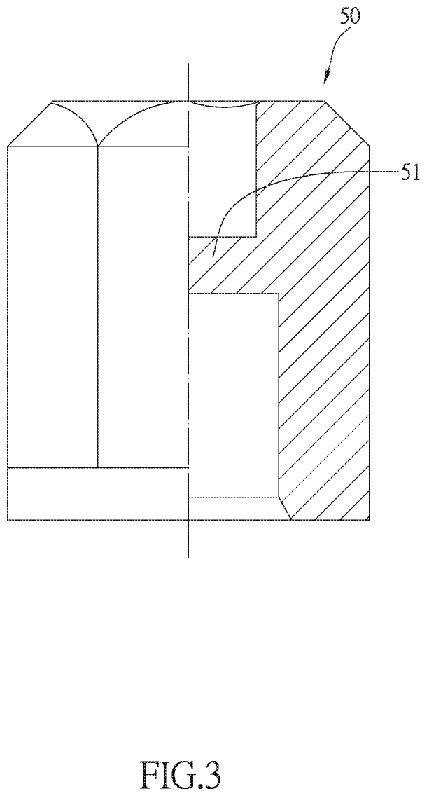

The outer nut 50 is hexagonal, but is not limited thereto, as long as it is polygonal. The outer nut 50 is sleeved tightly on the assembling portion 32 and at a distance from the end portion 12. Specifically, the outer nut 50 is abutted against another end of the inner nut 40 and partially located within the shaft hole 11. The outer nut 50 is not allowed to press the inner nut 40 when sleeved tightly on the assembling portion 32, otherwise the rotation may not be smooth. Further, an outer diameter of the outer nut 50 is larger than that of the inner nut 40. As shown in FIGS. 2 and 3, a positioning portion 51 is protruded from an inner surface of the outer nut 50 to provide for the assembling portion 32 to abut against. Through the configuration of the positioning portion 51, the outer nut 50 and the assembling portion 32 are maintained in a stable fixed relationship, thereby achieving the purpose of improving structural stability and safety, and ensuring excellent innovation and convenience.

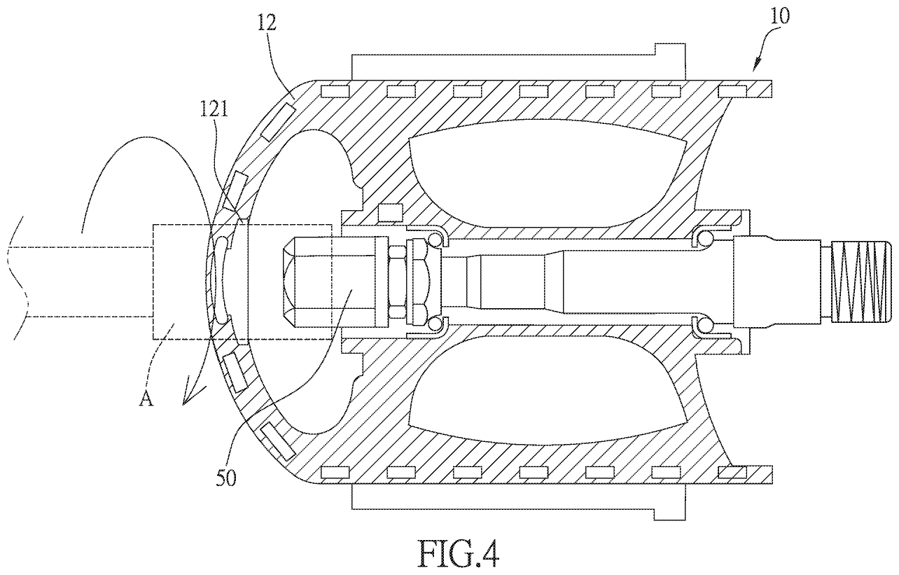

Referring to FIG. 4, the end portion 12 is provided with a through hole 121 that is aligned with one end of the outer nut 50. Specifically, when the assembler installs the quick release bicycle pedal on the crank of the bicycle, since the operation space of the present invention is significantly larger than that of the prior art, so that the assembler can assemble with a pneumatic tool, and the through hole 121 allows a socket A of the pneumatic tool to pass therethrough to engage with the outer nut 50. The assembler uses the pneumatic tool to accelerate the assembling or disassembling of the pedal, effectively shortening the assembling man-hour and reducing labor cost.

It is worth mentioning that the present invention can achieve the following effects:

The present invention provides a quick release bicycle pedal structure. By lengthening the assembling portion 32 of the shaft 30, the assembling portion 32 can extend out of the shaft hole 11 of the pedal body 10, and the outer nut 50 is added and disposed on the assembling portion 32 and can be assembled and disassembled with a pneumatic tool to accelerate assembling or disassembling of the pedal, effectively shortening the assembling man-hour and reducing labor cost. The pedal of the present invention is assembled from the end portion 12 of the pedal body 10, which improves the defects of the conventional operation space being narrow and small, significantly expands the operation space to enable the assembler to perform assembling in a more ergonomic manner, therefore, the assembler will not be fatigued during the assembling process, and the assembling will be smooth, convenient and safe.

While we have shown and described various embodiments in accordance with the present invention, it is clear to those skilled in the art that further embodiments may be made without departing from the scope of the present invention.

What is claimed is:

1. A quick release pedal for a bicycle comprising:
a pedal body including a shaft hole and an end portion at one end of the pedal body;
a shaft inserted in the shaft hole and including a connecting portion connecting a crank of the bicycle, and an assembling portion located opposite to the connecting portion and toward the end portion, the assembling portion extending out of the shaft hole; and
an outer nut sleeved on the assembling portion and at a distance from the end portion.

2. The quick release pedal for the bicycle as claimed in claim 1 further comprising two bearings and an inner nut, wherein the shaft hole is provided with two opposite step portions, the two bearings are respectively abut against the two step portions, and the inner nut has one end abutted against one of the two bearings, and another end for the outer nut to abut against.

3. The quick release pedal for the bicycle as claimed in claim 2, wherein an outer diameter of the outer nut is larger than that of the inner nut.

4. The quick release pedal for the bicycle as claimed in claim 1, wherein the end portion is provided with a through hole aligned with one end of the outer nut.

5. The quick release pedal for the bicycle as claimed in claim 1, wherein the outer nut is polygonal.

6. The quick release pedal for the bicycle as claimed in claim 1, wherein a positioning portion is protruded from an inner surface of the outer nut to provide for the assembling portion to abut against.

7. The quick release pedal for the bicycle as claimed in claim 1, wherein an inner diameter of a middle section of the shaft hole is smaller than an inner diameter at both ends of the shaft hole.
